(19) United States
(12) Patent Application Publication
(10) Pub. No.: US 2026/0104908 A1
(43) Pub. Date: Apr. 16, 2026

(54) METHOD FOR SYNCHRONIZING A DIGITAL TWIN WITH A PHYSICAL SYSTEM, AND ASSOCIATED ELECTRONIC DEVICE

(71) Applicant: Orange, Issy-les-Moulineaux (FR)

(72) Inventors: Thomas Hassan, CHATILLON CEDEX (FR); Maria Massri, CHATILLON CEDEX (FR)

(21) Appl. No.: 19/357,519

(22) Filed: Oct. 14, 2025

(30) Foreign Application Priority Data
Oct. 14, 2024 (FR) 2411092

(51) Int. Cl. G06F 9/455

(52) U.S. Cl. CPC G06F 9/45558

(57) ABSTRACT

The disclosed technology relates to a method for synchronizing at least a first digital twin 310 with a physical system 100 comprising: a plurality of synchronizations of the first digital twin 310 with the physical system 100, implemented according to a variable synchronization frequency; in response to a receipt of a request to obtain data from the physical system 100 at a current instant, a synchronization of at least a portion of the first digital twin with the physical system; and a reset of the synchronization frequency of the at least portion of the first digital twin to a value greater than a current value of said synchronization frequency.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### TECHNICAL FIELD

The disclosed technology belongs to the general field of the Internet of Things. It more particularly relates to a method for synchronizing a digital twin with a physical system. It also relates to a digital twin management device configured to implement such a method.

### BACKGROUND

A digital twin can be defined as a digital representation of a physical (or “real”) system, which has the particularity of evolving according to the transformations of the system to which it is attached. The particularity of a digital twin is that it relies on a physical model that is continuously powered by data which are for example collected by sensors disposed on, in or near the system, or derived from an inspection of this system at a specific instant.

Thus, unlike traditional digital modeling, a digital twin is generally configured to provide real-time information on the current operating state of the physical system to which it is connected, but also to simulate a scenario or anticipate some situations with regard to the past operation of this system.

The digital twins are a fast-growing technology and are increasingly used for the monitoring of complex systems—such as cities, industrial complexes, buildings, offshore platforms, wind turbines, aircraft engines, etc.—since they allow processing large amounts of heterogeneous data, identifying the root cause of problems and improving the productivity of these complex systems.

However, a digital twin of a complex system can be composed of several thousand variables that reflect the dynamics of this complex system. In other words, at an instant t, these are thousands of variables whose values can evolve in order to reflect an evolution of the complex system that this digital twin represents. Thus, the more complex the system becomes, the more difficult it becomes to obtain a digital twin that reflects all the changes in the system, and a fortiori, the more difficult it becomes to use the digital twin to predict the future performance or situations of the complex system.

Indeed, the synchronization of these thousands of variables, the use of the synchronized data to make new predictions, and the use of these new predictions to make decisions are costly operations in terms of time, bandwidth, and storage and/or processing resources. Moreover, not synchronizing a digital twin with the physical system it represents can lead to inaccurate predictions, especially in highly dynamic contexts.

### SUMMARY

The disclosed technology aims to overcome all or part of the drawbacks of other approaches, in particular those set out above, by proposing a solution that considers both the costs related to the synchronization of a (potentially large) amount of data and to the processing of these data, while ensuring that the quality of the predictions provided by the digital twin is maintained.

To this end, and according to a first aspect, the disclosed technology relates to a method for synchronizing a digital twin representing at least a portion of a physical system, the method being implemented by a digital twin management device and comprising:
a plurality of synchronizations of the first digital twin with the physical system, implemented according to at least one variable synchronization frequency;
in response to a receipt of a request to obtain data from the physical system at a current instant, a synchronization of at least a portion of the first digital twin with the physical system; and a reset of the synchronization frequency of the at least synchronized portion of the first digital twin to a value, called “reset value”, greater than a current value of said synchronization frequency.

This method according to an embodiment of the disclosed technology is advantageous because it helps, on the one hand, to reduce the frequency of the synchronizations—and therefore, a fortiori, to limit the amount of data exchanged between the physical system and its twin (e.g., the first twin), then processed by this twin—and, on the other hand, to enhance the frequency of the synchronizations of the portions of the twin which are for example required by a user of the management device and which are therefore of some interest to this user.

As mentioned previously, a digital twin corresponds to a digital and dynamic representation of a physical system. A digital twin relies on a physical model that is continuously powered by data collected in real time and offers a multitude of applications and benefits, in particular in the optimization of operations, the reduction of costs, the improvement of productivity and/or the increase of security.

In some modes of implementation, this physical model is formalized in the form of a graph whose nodes represent elements of the physical system, and whose edges represent the semantic (e.g., topological, spatial) relations between these elements. This model also comprises properties associated with the physical model itself, with the nodes and/or with the edges.

By “physical system” is meant any object or element, set of objects or elements, and/or environment composed of objects or elements. Examples include a city, an industrial complex, a building, an offshore platform, a wind turbine, an aircraft engine, a part of the human body, etc.

It is important to note that all or a portion of this physical system is represented by this first digital twin. In other words, this physical system is at least partially represented by the first digital twin.

The obtaining request is for example issued by a user of the digital twin management device. As a variant, this obtaining request is issued automatically by the digital twin management device, for example in response to the detection of an unusual event for example, or in response to a certain prediction.

As mentioned above, the synchronization of the first digital twin with the physical system in response to the receipt of the obtaining request may correspond to the synchronization of all or a portion of the digital twin. When this synchronization is only partial, it relates, for example:
to the synchronization of a portion of the first digital twin representative of a portion of the physical system. Thus, if the physical system corresponds to an automobile manufacturing plant, and if the obtaining request only targets a specific production line of this plant, only the portion of the twin representative of this specific production line is synchronized; or,
to the synchronization of one or several properties (or attributes) of the first digital twin or of the elements that compose it. Thus, if the obtaining request only concerns the values of the “ambient temperature” property, only the values of this property are then synchronized.
or to a synchronization of one or several properties of a portion of the digital twin, the latter case corresponding to the combination of the two cases previously mentioned. Thus, if the obtaining request only concerns the values of the “ambient temperature” property of robots located within a specific production line, only these values are synchronized.

In general, it is considered that the steps of a method should not be interpreted as being linked to a notion of temporal succession.

In some modes of implementation, the synchronization method may further include one or several of the following characteristics, taken individually or in all technically possible combinations.

In some modes of implementation, the plurality of synchronizations of the first digital twin with the physical system is implemented by gradually reducing an initial value of the synchronization frequency.

In some modes of implementation, the synchronization frequency is reset to a reset value distinct from the initial value. As a variant, the reset value and the initial value correspond to a single value.

In some modes of implementation, the synchronization frequency is gradually reduced by application of a decay function.

In some modes of implementation, the first digital twin comprises a prediction model, and the synchronization frequency is gradually reduced based on an effective accuracy of the prediction model.

In some modes of implementation, the synchronization frequency is gradually reduced as long as the effective accuracy of the prediction model is adapted.

By “Adapted” it is meant for example that this effective accuracy is above a threshold value. Thus, as long as the effective accuracy of the prediction model is above this threshold value to be reached, then the synchronization frequency is reduced.

In some modes of implementation, where only a portion P_{SYNC} of the first digital twin is synchronized in response to the receipt of the data obtaining request, the method further comprises a reset of the synchronization frequency for the portion P_{SYNC} (based on the reset frequency F_{INIT}), and the synchronization frequency of the digital twin, excluding the portion P_{SYNC}, is not reset and continues to vary as indicated above, based on the current value of the synchronization frequency.

In some modes of implementation, the first digital twin comprises a prediction model, and the method further comprises:
a generation of a state history of the physical system, each state of the history being associated with an instant t and including values of different dynamic variables of the physical system at said instant t; and,
a training of the prediction model by using the state history as training data.

In some modes of implementation, the synchronization method comprises:
a receipt of a request to obtain data from the physical system relating to an instant prior to the current instant,
a prediction, by the prediction model, of data associated with the earlier instant based on at least one state of the history when the state history does not comprise a state associated with the earlier instant.

In some modes of implementation, the synchronization method further comprises a recording of the predicted data at the earlier instant in the state history of the physical system.

In some modes of implementation, the method further comprises a determination of said at least portion of the first digital twin to be synchronized with the physical system, based on the data obtaining request.

In some modes of implementation, the synchronization method further comprises a storage, in the state history, of the data derived from the synchronization of the at least portion of the first digital twin with the physical system in association with the current instant.

In some modes of implementation, the synchronization method further comprises an access, by a rendering module, to the data derived from the synchronization of the at least portion of the first digital twin with the physical system.

In some modes of implementation, the synchronization method further comprises a filtering of the data derived from the synchronization of the at least portion of the first digital twin with the physical system.

In some modes of implementation, the plurality of synchronizations is achieved directly between the first digital twin and the physical system. As a variant, the plurality of synchronizations is achieved via a second digital twin representing at least partially the physical system.

As mentioned above, the characteristics mentioned above may be considered separately or in any technically possible combination.

According to a second aspect, the disclosed technology relates to a digital twin management device configured to implement a synchronization method according to an embodiment of the disclosed technology in any one of its modes of implementation.

According to a third aspect, the disclosed technology relates to a computer program including instructions for the implementation of a synchronization method, in any one of its modes of implementation, when said program is executed by a processor.

This program may use any programming language, and may be in the form of source code, object code, or intermediate code between source code and object code, such as in a partially compiled form, or in any other desirable form.

According to a fourth aspect, the disclosed technology relates to a computer-readable recording medium on which is recorded the computer program according to an embodiment of the disclosed technology in any one of its modes of implementation.

The information or recording medium may be any entity or device capable of storing the program. For example, the medium may include a storage means such as a ROM for example a CD-ROM or a microelectronic circuit ROM, or a magnetic recording means for example a hard disk.

On the other hand, the information or recording medium may be a transmissible medium such as an electrical or optical signal, which may be conveyed via an electrical or optical cable, by radio or by other means. The program according to an embodiment of the disclosed technology may be particularly downloaded from an Internet-type network.

Alternatively, the information or recording medium may be an integrated circuit in which the program is incorporated, the circuit being adapted to execute or to be used in the execution of the method in question.

### BRIEF DESCRIPTION OF THE DRAWINGS

Other characteristics and advantages of the disclosed technology will emerge from the description given below, with reference to the appended drawings which illustrate one exemplary embodiment thereof without any limitation. In the figures:

FIG. 1 is a representation of one exemplary environment in which the disclosed technology is implemented;

FIG. 2 represents modules embedded in a digital twin management device, according to one exemplary implementation of the disclosed technology;

FIG. 3 schematically represents one exemplary hardware architecture of a digital twin management device;

FIG. 4 represents, in the form of a flowchart, some modes of implementation of a synchronization method, for example executed by the digital twin management device of FIGS. 2 and 3; and,

FIG. 5 is a representation of one exemplary environment in which the disclosed technology is implemented.

### DESCRIPTION OF THE EMBODIMENTS

The terms “first”, “second”, etc. are used in this document by arbitrary convention to allow identifying and distinguishing different elements (such as messages, devices, digital twins, etc.) considered in the embodiments described below, and do not imply any particular sequencing, except where explicitly indicated.

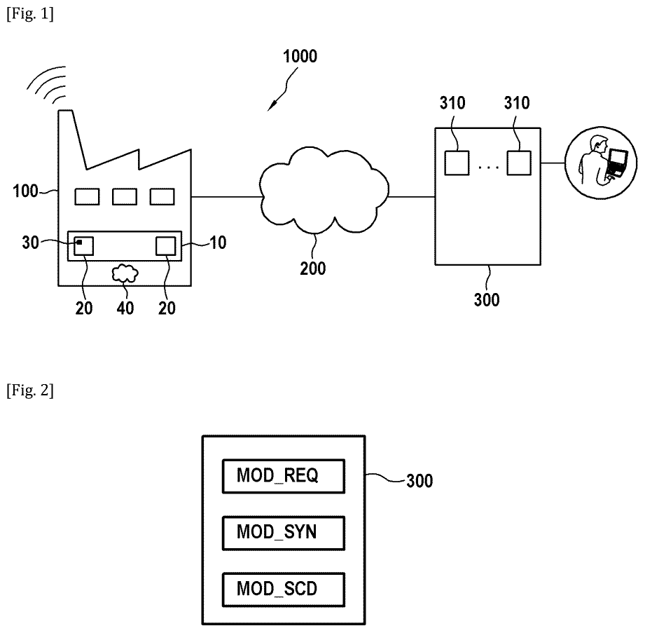

FIG. 1 is a representation of one exemplary environment 1000, in which an embodiment of the disclosed technology is implemented.

As illustrated in FIG. 1, this environment 1000 comprises a physical system. This system corresponds in this example to a vehicle manufacturing plant 100 and comprises a production (for example mounting) line 10. This production line comprises a set of specialized workstations consisting of industrial robots 20 disposed in a pre-established order corresponding to the succession of the operations of assembling the components of a vehicle. Each robot 20 is itself equipped with one or several sensor(s) 30. These sensors correspond for example to:
a 2D vision sensor for example to allow detecting moving objects or searching for items on a conveyor belt. The robot can then adjust its motion appropriately based on the received information;
a 3D vision sensor;
a positioning sensor such as a Global Positioning System (GPS);
a gyroscopic sensor for example to allow the robot to maintain a certain orientation;
a sound sensor for example configured to assess the amplitude of the sounds in the environment of the robot relative to a threshold value;
a proximity sensor configured to detect a nearby object, without physical contact with that object, so as to allow the robot to avoid a collision;
a tactile sensor (or “contact sensor”);
a force sensor configured to assess a physical force (e.g., a weight, a tension, a compression or a pressure); and/or
a temperature sensor.

The production line 10 and/or the plant 100 may also be equipped with sensor(s) 30, such as motion detection sensors, cameras, temperature sensors, smoke detection sensors, etc.

In the present example, and for the purpose of simplifying the description, it is considered that the plant 100 comprises only a single production line 10. However, it should be noted that no limitation is attached to the number of production lines, to the number of robots that compose this or these production line(s) 10, and/or to the types of considered sensors. The following developments can indeed be easily generalized by those skilled in the art.

This vehicle manufacturing plant 100 is connected to a digital twin management device 300 through a telecommunications network 200. It should be noted that no assumption is made regarding the nature of this network. This may be for example a local network (for example a Local Area Network, LAN or a Wireless LAN, WLAN), a wide area network such as the Internet, a mobile telephone network (for example a Fifth Generation (5G) or a Beyond Fifth Generation (B5G) network), or a combination of these different types of networks.

This manufacturing plant 100 also comprises a local network 40. No assumption is made as to the nature of this network.

A “digital twin management platform” is installed on this digital twin management device 300, which hosts one or several digital twin(s) 310.

Subsequently, the detailed embodiments are described, by way of example, by considering the presence of a single digital twin. It should however be noted that the number of digital twins does not constitute a limitation of the disclosed technology, and nothing precludes envisaging a number of digital twins greater than one, for example when several physical systems are considered and/or when several elements of the same physical system are represented by several digital twins.

This digital twin management platform, used for example within the framework of the organization or of optimization of this vehicle manufacturing plant 100, is for example configured to:
analyze, in real time, the data derived from sensors associated with one or several physical system(s) (for example, detect an abnormal situation such as a defect in a part from images captured by the 2D or 3D vision sensors);
predict the behavior of the vehicle manufacturing plant 100 as a whole or of one or several element(s) of this plant 100 (for example, predict the behavior of a robot 20, and/or predict the wear of a part in order to improve the maintenance planning);
simulate a pre-established scenario (for example simulate a breakdown in this vehicle manufacturing plant 100 as well as its consequences, or simulate a new manufacturing process);
assess the causes of a specific (for example unusual) behavior of one or several element(s) of the vehicle manufacturing plant 100, or of the plant 100 as a whole, for example from the analysis of a state history of the physical system; and/or
offer, to a user, a synthetic representation of the vehicle manufacturing plant 100 as a whole and/or of one or several element(s) of this plant 100.

To do so, the digital twin management platform hosts a digital twin attached to all or a portion of the physical system 100. In other words, the physical system 100 is represented at least partially by a digital twin.

The digital twin management device 300 may for example be associated with a (local or remote) database in which the data relating to the hosted digital twin are stored. This database is for example configured to store:
a data model associated with the digital twin;
data continuously collected by the sensors 30 equipping the plant 100 (and/or the elements that comprise it) and received by the twin management device 300, these data being used to update the data model mentioned above;
metadata associated with the twin. These metadata comprise for example the creation date of this twin, the date of the last update, the expiration date, the owner or the manager of this twin, a visibility and/or confidentiality indicator;
and possibly, when the platform hosts several digital twins 310, data representative of the relations between these digital twins.

FIG. 2 represents modules embedded in a digital twin management device 300, according to one exemplary implementation of the disclosed technology.

As illustrated in FIG. 2, the digital twin management device 300 comprises:
a module MOD_REQ for receiving a request to obtain data from the physical system at a current instant t_{CUR};
a synchronization module MOD_SYN configured to synchronize the digital twin 310 with the physical system 100;
a scheduling module MOD_SCD configured to adjust the synchronization frequency of the digital twin 310 with the physical system 100. As discussed in more detail below, in some modes of implementation, this scheduling module MOD_SCD is configured to gradually reduce a synchronization frequency of said digital twin 310 with said physical system 100, but also to reset the synchronization frequency to a reset value, in response to an instruction received from the module MOD_REQ for receiving a request.

Their functionalities are described in more detail below with reference to different modes of implementation.

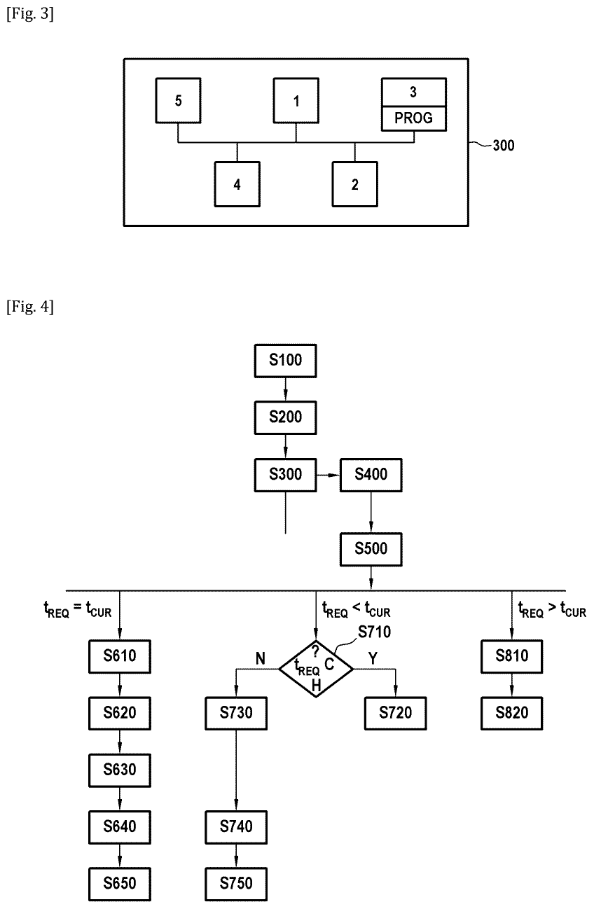

FIG. 3 schematically represents one example of hardware architecture of a digital twin management 310 device 300.

As illustrated in FIG. 3, the digital twin management device 300 has the hardware architecture of a computer. Thus, the digital twin management device 300 includes, in particular, a processor 1, a random-access memory 2, a read-only memory 3 and a non-volatile memory 4. It also has communication means 5.

The read-only memory 3 of the digital twin management device 300 constitutes a recording medium in accordance with an embodiment of the disclosed technology, readable by the processor 1 and on which is recorded a computer program PROG in accordance with an embodiment of the disclosed technology, including instructions for the execution of steps of the synchronization method according to an embodiment of the disclosed technology. The program PROG defines functional modules of the digital twin management device 300, which rely on or control the hardware elements 1 to 5 of the digital twin management device 300 cited above. These functional modules are illustrated in FIG. 2 without limitation, and are described in more detail below with reference to different modes of implementation.

In the modes of implementation described below, the communication means 5 allow in particular the digital twin management device 300 to obtain data generated by sensors connected to the physical system 100. For this purpose, the communication means 5 include a wired or non-wired communication interface able to implement any suitable communication protocol.

In some modes of implementation, the digital twin management device 300 comprises and/or is further connected to a human-machine interface HMI, making it possible to offer, to a user, a synthetic representation of all or a portion of the physical system to be piloted. This HMI also allows a user to request a prediction of the behavior of the physical system; to start a simulation of a pre-established scenario; and/or to start an assessment of the causes of a specific behavior of the physical system.

In some modes of implementation, the digital twin 310 comprises a prediction model which is for example stored in non-volatile memory 4 of the digital twin management device 300.

FIG. 4 represents, in the form of a flowchart, some modes of implementation of a synchronization method, for example executed by the digital twin management device 300 of FIGS. 2 and 3.

As illustrated in FIG. 4, the synchronization method comprises a first step S100 of obtaining a state history H={S₁, S₂, . . . , S_{T}} of the physical system 100. According to some modes of implementation, the state history is generated by the digital twin management device 300 itself, and this step S100 of obtaining a state history then corresponds to a step of generating the state history H of the physical system 100. As a variant, the history is generated by a device distinct from the digital twin management device 300, and this step S100 of obtaining a state history corresponds to a receipt of the state history H. Each state of the history H corresponds to a synchronization between the digital twin and all or a portion of the physical system, or to the result of a prediction of the state of all or a portion of the physical system at an instant prior to the current instant.

Each state of the history is in particular composed of properties whose values are dynamic and which reflect the evolution of the behavior and/or state of the physical system 100 over time. These values are typically transmitted by different sensors installed in, on or near the physical system, such as the sensors 30 previously mentioned with reference to FIG. 1.

According to some modes of implementation, during a synchronization, the entire physical system 100 is synchronized. As a variant, only a portion of the physical system 100 is synchronized.

According to some modes of implementation, all properties are synchronized. As a variant, only some properties are synchronized. In other words, during the generation of this history H, the properties p₁, p₂, and p₃ can be synchronized during the instant t₁, and the properties p₁, p₃, p₄, and p₅ during the instant t₂.

Each state can also be composed of metadata that characterize this physical system or some elements of this physical system. These metadata correspond for example to a name, an identifier, a brand, a manufacturer, an address and/or a location.

Each state is recorded with a timestamp representative of the moment where the data were synchronized. Both the timestamp and the state data can be “serialized,” that is to say, converted into a semi-structured format (such as JSON). The timestamp can be serialized for example by using a Unix timestamp or by following the ISO 8601 standard, while the state data can for example be serialized in the form of one or several JSON value(s), by following the RFC8259 standard. In this case, each state S₁, S₂, . . . , Sₜ consists of one of the basic JSON value types: “object, array, number, string of characters, or one of the values “false, true, null”.

The following example considers the digital twin of a robot 20 with a gripper. The history H consists of two states S₁, S₂, and the state S₁ is expressed as follows:

{
“id”: “90363aff-7eba-4b97-8a17-527907c939ca”,
“timestamp”: “2024-02-26T14:26:57.101Z”,
“temperature”: 24.0,
“force”: 45.2,
“distance”: 0.8
}

where “force” corresponds to the force exerted by the gripper in Newton, and “distance” corresponds to a distance relative to the object closest to the robot 20. The state S₂ is expressed as follows:

{
“id”: “90363aff-7eba-4b97-8a17-527907c939ca”,
“timestamp”: “2024-02-26T15:26:57.101Z”,
“temperature”: 24.8,
“force”: 47.9,
“distance”: 0.7
}

Of course, other structured or semi-structured formats can be envisaged to serialize these states, such as XML (Extensible Markup Language) or CVS (Comma-Separated Values).

The synchronization method further comprises a step S200 of training a prediction model of the digital twin 310, by using the history H of states obtained during step S100.

In some modes of implementation, this model is configured to predict missing data at an instant t_{PASS} prior to the current instant t_{CUR}. As a variant or in addition, this model is for example configured to predict the behavior of the physical system 100 and/or to simulate a pre-established scenario.

In some modes of implementation, the prediction model is for example implemented in the form of neural networks (convolution, perceptron, autoencoder, recurrent, etc.). According to some implementations, the neural networks considered are for example recurrent neural networks of the “Long Short-Term Memory” (LSTM) type.

Moreover, it is important to note that no limitation is attached to the type of training technique used to obtain this prediction model. Any technique implementing a learning algorithm (machine learning) and providing, as output, a missing data at an earlier instant and/or a prediction according to the embodiment considered, given a history of states H corresponding to input data, can be considered in the context of the disclosed technology (for example, support vector machine, logistic regression, etc.). In other words, the prediction model is independent of the training method considered to train this model.

Furthermore, the training criteria may vary depending on the modes of implementation during the training phase of this prediction model. For example, a training criterion such as the least squares method or the cross-entropy minimization can be used.

This training S200 is optional in some modes of implementation, for example when the method uses a previously trained model or a model that does not require training.

The synchronization method further comprises a step S300 of synchronizing the digital twin with the physical system, during which all or a portion of the digital twin is synchronized with the physical system, by adapting a variable synchronization frequency. This step S300 of synchronizing the digital twin with the physical system is for example implemented by the module MOD_SYN of the digital twin management device 300, in response to an instruction received from the module MOD_SCD of this device.

In some modes of implementation, this synchronization is achieved by gradually reducing the synchronization frequency of said digital twin with said physical system.

The synchronization frequency value used when starting the method (“initial” frequency ƒ₀) is either predetermined (for example predetermined by an administrator of the digital twin management platform, or configured based on user preferences and/or on the envisaged application), or chosen dynamically, automatically or manually when starting the method. Thus, in some modes of implementation, if the digital twin is used to monitor, in real time, the production of an industrial system, an initial value ƒ₀ from 2 to 8 Hz can be envisaged.

According to at least some modes of implementation of step S300 of synchronizing the digital twin with the physical system, the synchronization frequency is gradually reduced. The variation may be automatic, for example by application of a decay function ƒ_{DEC}.

According to another mode of implementation of step S300 of synchronizing the digital twin with the physical system, the synchronization frequency may vary iteratively, depending on the result of a comparison between an effective accuracy of the prediction model and a first accuracy value (used as a threshold).

For example, at each synchronization (or as a variant after a constant number of synchronizations), the effective accuracy of the prediction model may be assessed, for example by using the Mean Squared Error (MSE) or the Root Mean Square Error (RMSE). Then, the effective accuracy is compared with the first accuracy value (“threshold”): if the effective accuracy is greater than this first accuracy value, then the applied synchronization frequency is reduced by a first value (such as 0.0015 Hz with reference to the example above) or by a first percentage. On the other hand, if the effective accuracy is lower than the first accuracy value is reached, then the applied synchronization frequency is increased by a second value (such as 0.002 Hz with reference to the example above) or by a second percentage.

The synchronization method further comprises a step S400 of receiving a request to obtain data representative of the state of the physical system at an instant t_{REQ}. This may be a past or future instant, or the current instant. This step is for example implemented by the module MOD_REQ of the digital twin management device 300. In some modes of implementation, this request to obtain data is issued by a user of the digital twin management device. As a variant, this request to obtain data is issued automatically by the digital twin management device, for example in response to the detection of an unusual event, in response to a certain prediction and/or in response to a simulation of a pre-established scenario.

During a step S500, the digital twin management device 300 compares the instant t_{REQ} Specified in the received request with the current instant t_{CUR}. More specifically, it determines whether the instant t_{REQ} specified in the request received during the step S400 of receiving a request to obtain data corresponds to the current instant t_{CUR}, to a past instant t_{PASS} (prior to the current instant), or to a future instant (subsequent to the current instant).

As discussed in more detail below, different steps are implemented depending on whether or not the instant t_{REQ} specified in the request corresponds to the current instant t_{CUR}. If the instant t_{REQ} corresponds to the current instant t_{CUR} (choice “t_{REQ}=t_{CUR}”), the steps referenced S610, S620, S630, S640 and S650 (set out below) are implemented.

During step S610 of identifying at least a portion of the twin to be synchronized, at least a portion of the twin to be synchronized is identified based on the content of the request received during step S400.

According to some modes of implementation, the entire digital twin is identified as having to be synchronized.

According to other modes of implementation, only a portion of the digital twin, for example identified in the request by an identifier (“ID”), a class or a field of application is identified as having to be synchronized. Thus, if the request aims for example only to obtain that the data relating to a specific production line of this plant, only the portion of the twin representative of this specific production line is synchronized.

According to some modes of implementation, a physical system is represented by several digital twins that can be linked together by semantic relations. Thus, with reference to the example illustrated in FIG. 1, each industrial robot 20 is for example represented by a digital twin (called “third twin”), the production line is itself represented by a digital twin (called “fourth twin”, the third twins being linked to the fourth twin by the topological relation “is a portion of”), the local network 40 within this plant is represented by a digital twin (called “fifth twin” linked to the third and fourth twins) and the manufacturing plant 100 is itself represented by a digital twin including the third, fourth, fifth digital twins.

In the example mentioned above, since the request only aims to obtain the data relating to a specific production line in this plant, only the fourth digital twin representative of this production line is synchronized. However, the twin representative of the local network 40 within the plant is not resynchronized.

According to another mode of implementation, only the properties of a digital twin or the elements that compose it are synchronized.

The method further comprises a step S620 during which the at least portion of the twin to be synchronized, identified during the identification step S610, is synchronized with the physical system 100. This step is for example implemented by the module MOD_SYN of the digital twin management device 300.

The synchronization method further comprises a step S630 for resetting the synchronization frequency to a reset value greater than the current synchronization frequency value. This reset value corresponds for example—but not necessarily—to the initial value ƒ₀ previously mentioned.

In other words, in the modes of implementation during which the synchronization frequency of the twin has been gradually reduced during the various synchronizations of step S300, this synchronization frequency is increased again. This step S630 of resetting the synchronization frequency is advantageous since it allows enhancing the frequency of the synchronizations of the portions of the twin that are for example required by a user of the management device (or by the management device itself), and which are therefore of some interest to this user (or to the management device itself). The step S630 of resetting the synchronization frequency is for example initiated and/or controlled by the module MOD_SCD of this device.

Note that if only a portion of the digital twin has been synchronized during the synchronization step S620, this results in a digital twin such as the digital twin representative of the manufacturing plant 100, having portions synchronized at different synchronization frequencies.

The method further comprises a step S640 of de-storing the synchronized data in the history H in association with the current instant t_{CUR}.

Finally, a processing step S650 is implemented during which the synchronized data are processed. According to some modes of implementation, this processing comprises a “rendering” (that is to say a display or an audio restitution for example) of all or a portion of the synchronized data. In the case where the rendering is visual, the digital twin management device is for example connected to a graphical interface allowing a display of the generated data. The use of a graphical interface allowing a display of the data of course constitutes only one example of implementation, and any interface associated with the digital twin management device allowing a user to access the generated data—and this regardless of the considered access modality—can be envisaged.

According to some modes of implementation, this processing comprises an analysis of the generated data, for example with a view to predicting the behavior of the physical system represented, simulating a pre-established scenario or assessing the causes of a specific behavior of the physical system.

During step S500 of comparing the instant t_{REQ} with the current instant t_{CUR}, if the instant t_{REQ} corresponds to a past instant t_{PASS} (step S500, choice “t_{REQ}<t_{CUR}”), the steps S710 and S720 or the steps S710, S730, S740 and S750 are implemented.

The step S710 of determining the presence of a state in association with this instant t_{REQ} in the state history H is implemented during which it is determined whether a state in association with this instant t_{REQ} is recorded in the state history H. If this is the case (step S710, choice “Y”), a step S720 of processing the data of this state from the state history H is implemented. According to some modes of implementation, the operations implemented during this step S720 are similar to those described with reference to step S650 of processing the synchronized data.

On the other hand, if the state history H does not comprise a state in association with the instant t_{REQ} (step S710, choice “N”), a step S730 of generating data in association with the instant t_{REQ} is implemented during which the data required at the instant t_{REQ} are generated by the prediction model mentioned above, based on at least one of the states of the history for at least one instant close to the instant t_{REQ}. In some modes of implementation, the state of the history at the instant immediately preceding the instant t_{REQ} and/or the state immediately following the instant t_{REQ} is taken into account to generate the required data. In some modes of implementation, the states of the history at the n instants immediately preceding the instant t_{REQ} and/or immediately following the instant t_{REQ} are taken into account to generate the required data.

In some modes of implementation, the synchronization method further comprises a step S740 of storing, in the history H, the data generated during the data generation step S730 in association with the instant t_{REQ}. Such storage allows avoiding soliciting the prediction model if these data relating to the instant t_{REQ} are required again in the future.

It is noted that this step may be optional in some embodiments (so as to limit for example the memory occupation of the history).

Finally, in some modes of implementation, the method comprises a step S750 of processing the data generated during the data generation step S730 in association with the instant t_{REQ}. According to some modes of implementation, the processing operations implemented during this step S750 are similar to those described with reference to the synchronized data processing step S650.

If, during the step S500 of comparing the instant t_{REQ} with the current instant t_{CUR}, the instant t_{REQ} corresponds to a future instant (step S500, choice “t_{REQ}>t_{CUR}”), an error message, intended for the user who issued the request received during the step S400 of receiving a request to obtain data, is issued in some modes of implementation. In other modes of implementation, a prediction from the history can be performed (step S810) and a step S820 of processing the data from this prediction is implemented. According to some modes of implementation, the processing operations implemented during this step S820 are similar to those described with reference to step S650 of processing the synchronized data.

In some modes of implementation, a filtering step (not represented in FIG. 4) is implemented prior to the processing steps S650, S750, S720 and/or S820.

The term “filtering” (or “selection”) is used within the framework of requests to access databases. It is in fact an analysis of the user request, to identify the digital twins concerned by the synchronization (or the concerned portions of a digital twin). In the following description, two illustrative examples are described: the first example (“Example #1”) processes a simple request aiming a synchronization of an entire digital twin, the second example (“Example #2”) is relative to a request that concerns the elements of a twin whose attribute (“temperature”) is in a particular state (>19° C.). In this case, it is possible to:
either synchronize all the elements having the concerned attribute (“temperature”), then return information only for the elements having an attribute in the particular state (“>19° C.”) (hence the term “filtering”) before a rendering step described below.
or identify, via the history, the elements whose attribute (“temperature”) has this particular state (“>19° C.”) (for example during step S610, or before/during step S730 and/or step S810, namely during step 500) and then synchronize these twins.

Synchronizing then filtering may offer advantages in terms of reliability since the current state of the attribute is systematically ensured. Filtering then synchronizing may offer advantages in terms of speed (since only a portion of the twins will be synchronized). For example, either of these approaches can be chosen based on the time elapsed since the last synchronization of the concerned twins.

When the filtering relates to past or future missing data (that is to say when it is applied prior to steps S750, S720, and/or S820), synchronization with the physical system is not possible during the processing of the user request.

For a future state, it is therefore required to essentially use states predicted by the predictive model to determine the elements corresponding to the filter and to respond to the request. In order not to over-solicit the data generation, the request may include one or several element(s) of identification of the system(s) for which it is necessary to predict values.

### EXAMPLES

i) a request for a twin (or a portion of a twin representative of an element) identified by its identifier and one or several attribute(s) in their future state. In this case, the generation of the missing data can be carried out immediately and then the result of the request is returned to the user;
ii) a request for a set of twins (representative of several elements of the physical system) identified by their respective identifiers and one or several attribute(s) in their future state;
iii) a request for an indeterminate set of twins (representative of several elements of the physical system), and one or several attribute(s) in their future state.

In the cases ii) and iii), a predetermined limit max_n of the number of twins (or elements) can be envisaged, for example by following the following procedure:
a user request for an unknown number of twins is received;
a number of twins (or elements) n corresponding to the filter is determined;
if n<max_n, the step of predicting the missing states is implemented;
and if n>max_n, the method stops and/or an error message is transmitted to the user.

For a past state, if no data corresponding to the filter and to the requested past instant is stored, new data can be generated by the predictive model. In this case, the elements described above for the future states are resumed.

### Examples of User Requests

The following examples rely on SQL language, as well as on the query language of a database MongoDB. It is however important to note that other languages could be considered.

### Example #1: Request to Obtain Data at the Instant “2024-02-26T16:00:57.101Z” from a Twin Identified by its ID

As mentioned previously: this first example (“Example #1”) processes a request concerning an entire digital twin.

The corresponding request SQL can be expressed as follows:

SELECT * FROM DigitalTwin WHERE id == “90363aff-7eba-4b97-
8a17-527907c939ca” and timestamp == “2024-02-
26T16:00:57.101Z”

And by using the MongoDB request language:

{
“id”: “90363aff-7eba-4b97-8a17-527907c939ca”,
“timestamp”: “2024-02-26T16:00:57.101Z”
}

In this example, all the properties of the twin with the identifier “90363aff-7eba-4b97-8a17-527907c939ca” are synchronized.

### Example #2: Request to Obtain Data at the Instant “2024-02-26T16:00:57.101Z” with Filtering of a Property (Temperature>19° C.)

As mentioned previously, this second example (Example #2) is relative to a request that concerns one or several element(s) whose attribute (“temperature”) is in a particular state (>19° C.).

The corresponding SQL request can be expressed as follows:

SELECT * FROM DigitalTwin WHERE temperature > 19 and timestamp
== “2024-02-26T16:00:57.101Z”

And by using the MongoDB request language:

{
“temperature”: { $gte: 19 },
“timestamp”: “2024-02-26T16:00:57.101Z”
}

According to some modes of implementation, the synchronization module MOD_SYN can start the synchronization, but without limitation at a temperature above 19° C. Indeed, the initially received request can be decomposed, and during a first step, initially, all twins having a “temperature” property are synchronized.

This first step is then equivalent to the following SQL request:

SELECT * FROM DigitalTwin WHERE temperature IS NOT NULL and
timestamp == “2024-02-26T16:00:57.101Z”

And by using the MongoDB request language:

{
“temperature”: { $ne: null },
“timestamp”: “2024-02-26T16:00:57.101Z”
}

In this case, all the twins with a “temperature” property are synchronized, even if the “temperature” property has a value less than or equal to 19° C. In this mode of implementation, the second filtering step will then be implemented for example during the step S900 of accessing the data.

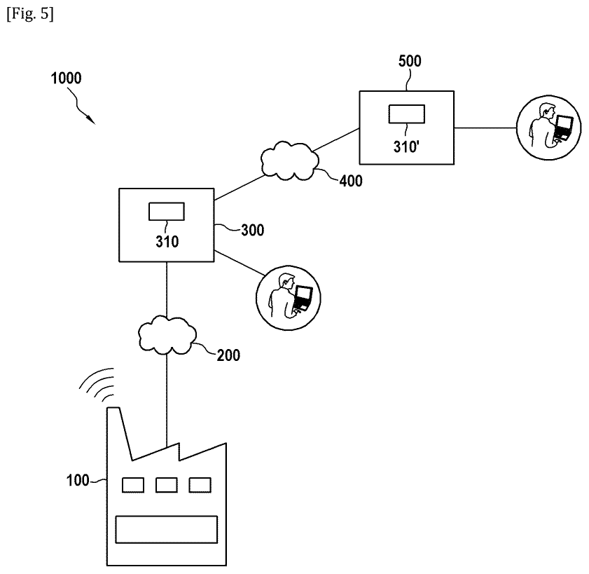

FIG. 5 is a representation of one exemplary environment in which the disclosed technology is implemented.

This FIG. 5 differs from FIG. 1 in that the digital twin management device 300 is connected to another digital twin management device 500 through the telecommunications network 400. This other digital twin management device 500 comprises a replica 310′ of the digital twin 310 of the vehicle manufacturing plant 100. In other words, the digital twin 310 is distributed among several digital twin management devices, which therefore allows a user to interact with the closest device, for example in order to reduce the data access time caused by the physical distance between the user and the digital twin management device.

In some modes of implementation, the twin 310 of the device 300 closest to the physical system 100 is regularly synchronized with the physical system 100, for example at the initial frequency ƒ₀, and the method according to an embodiment of the disclosed technology is then implemented by the device 500 in charge of the digital twin 310′. In this particular case, the digital twin 310′ corresponds to a replica of the digital twin 310, but the two twins 310 and 310′ are not synchronized with the physical system 100 by using the same synchronization frequency.

More specifically, the digital twin management device 500 implements the following steps:
a plurality of synchronizations of at least a portion of the digital twin 310′ with the digital twin 310 implemented according to at least one variable synchronization frequency. In some modes of implementation, this step comprises a gradual reduction of the synchronization frequency of the digital twin 310′ with the digital twin 310 as long as the effective accuracy of the prediction model of the digital twin 310′ is adapted;
in response to a receipt of a request to obtain data from the physical system at a current instant, a synchronization of at least a portion of the digital twin 310′ with the digital twin 310, and a reset of the synchronization frequency of the at least portion of the digital twin 310′ with the digital twin 310 to a value greater than a current value of said synchronization frequency.

1) A method for synchronizing a first digital twin representing at least a portion of a physical system, the method being implemented by a digital twin management device and comprising:
a plurality of synchronizations of the first digital twin with the physical system, implemented according to at least one variable synchronization frequency; and
in response to a receipt of a request to obtain data from the physical system at a current time:
a synchronization of at least a portion of the first digital twin with the physical system; and
a reset of the synchronization frequency of the at least a portion of the first digital twin to a value greater than a current value of said synchronization frequency.

2) The method of claim 1, the first digital twin comprising a prediction model, and wherein the synchronization frequency being gradually reduced based on an effective accuracy of the prediction model.

3) The method of claim 2, the synchronization frequency being gradually reduced as long as the effective accuracy of the prediction model is adapted.

4) The method of claim 1, wherein only a portion of the first digital twin is synchronized in response to the receipt of the data obtaining request, the method further comprising a synchronization of the portion of the first digital twin based on the reset frequency, and a synchronization of the digital twin excluding the portion of the first digital twin based on a current value of the synchronization frequency.

5) The method of claim 1, the first digital twin comprising a prediction model, the method further comprising:
a generation of a state history of the physical system, each state of the history being associated with a respective time and including values of different dynamic variables of the physical system at said respective time; and,
a training of the prediction model by using the state history as training data.

6) The method of claim 5, further comprising:
a receipt of a request to obtain data from the physical system relating to a time prior to the current time,
a prediction, by the prediction model, of data associated with the earlier time based on at least one state of the history when the state history does not comprise a state associated with the earlier time.

7) The method of claim 6, further comprising a recording of the predicted data at the earlier time in the state history of the physical system.

8) The method of claim 1, further comprising a determination of said at least portion of the first digital twin to be synchronized with the physical system, based on the data obtaining request.

9) The method of claim 1, further comprising a storage, in the state history, of data derived from the synchronization of the at least portion of the first digital twin with the physical system in association with the current time.

10) The method of claim 1, further comprising an access, by a rendering module, to the data derived from the synchronization of the at least portion of the first digital twin with the physical system.

11) The method of claim 1, further comprising a filtering of the data derived from the synchronization of the at least portion of the first digital twin with the physical system.

12) The method of claim 11, comprising, during said filtering, a generation of missing data by a prediction model of said digital twin.

13) The method of claim 1, the plurality of synchronizations being achieved directly between the first digital twin and the physical system, or via a second digital twin representing at least partially the physical system.

14) A device comprising at least one processor; and a non-transitory computer-readable medium storing instructions which, when executed by the at least one processor, cause the at least one processor to carry out operations comprising:
achieving a plurality of synchronizations of a first digital twin with a physical system, the first digital twin representing at least a portion of said physical system, the plurality of synchronizations being implemented according to at least one variable synchronization frequency; and
in response to a receipt of a request to obtain data from the physical system at a current time:
synchronizing at least a portion of the first digital twin with the physical system; and
resetting the synchronization frequency of the at least a portion of the first digital twin to a value greater than a current value of said synchronization frequency.

15) The device of claim 14, wherein the first digital twin comprises a prediction model, the synchronization frequency being gradually reduced based on an effective accuracy of the prediction model.

16) The device of to claim 14, wherein only a portion of the first digital twin is synchronized in response to the receipt of the data obtaining request, said medium further storing instructions which, when executed by the at least one processor, cause the at least one processor to synchronize the portion of the first digital twinbased on the reset frequency, and to synchronize the digital twin excluding the portion of the first digital twin based on a current value of the synchronization frequency.

17) The device of claim 14, wherein the first digital twin comprises a prediction model, said medium further storing instructions which, when executed by the at least one processor, cause the at least one processor to:
generate a state history of the physical system, each state of the history being associated with a respective time and including values of different dynamic variables of the physical system at said respective time; and,
train said prediction model by using the state history as training data.

18) The device of claim 14, wherein said medium further stores instructions which, when executed by the at least one processor, cause the at least one processor to filter data derived from synchronization of the at least a portion of the first digital twin with the physical system.

19) The device of claim 18, wherein said medium further stores instructions which, when executed by the at least one processor, cause the at least one processor to generate, during said filtering, missing data by a prediction model of said digital twin.

20) A non-transitory computer-readable storage medium on which are stored instructions which, when executed by at least one processor of a computer, cause the at least one processor to carry out operations comprising:
achieving a plurality of synchronizations of a first digital twin with a physical system, the first digital twin representing at least a portion of said physical system, the plurality of synchronizations being implemented according to at least one variable synchronization frequency; and
in response to a receipt of a request to obtain data from the physical system at a current time:
synchronizing at least a portion of the first digital twin with the physical system; and
resetting the synchronization frequency of the at least a portion of the first digital twin to a value greater than a current value of said synchronization frequency.
